(19) United States
(12) Patent Application Publication
(10) Pub. No.: US 2006/0159907 A1
(43) Pub. Date: Jul. 20, 2006

(54) Filled ultramicrocellular structures

(76) Inventors: Simona Percec, Philadelphia, PA (US); Maria Spinu, Hockessin, DE (US); Irene Greenwald Plotzker, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/295,804

(22) Filed: Dec. 7, 2005

Related U.S. Application Data
(60) Provisional application No. 60/635,141, filed on Dec. 10, 2004.
(60) Provisional application No. 60/635,273, filed on Dec. 10, 2004.
(60) Provisional application No. 60/635,274, filed on Dec. 10, 2004.
(60) Provisional application No. 60/635,276, filed on Dec. 10, 2004.
(60) Provisional application No. 60/635,277, filed on Dec. 10, 2004.
(60) Provisional application No. 60/635,304, filed on Dec. 10, 2004.
(60) Provisional application No. 60/635,375, filed on Dec. 10, 2004.

(51) Int. Cl. B32B 3/26; B32B 3/06; B32B 9/00

(52) U.S. Cl. 428/315.5; 428/304.4; 428/920; 428/306.6; 428/318.4

(57) ABSTRACT

This invention relates to ultramicrocellular structures that incorporate fillers such as functional fillers.

This application claims the benefit of U.S. Provisional Applications Nos. 60/635,141, 60/635,273, 60/635,274, 60/635,276, 60/635,277, 60/635,304 and 60/635,375, filed on Dec. 10, 2004, each of which is incorporated in its entirety as a part hereof for all purposes.

### TECHNICAL FIELD

This invention relates to ultramicrocellular structures that incorporate fillers such as functional fillers.

### BACKGROUND

In recent years, interest has grown in materials that can actively respond to environmental factors such as thermal, mechanical, optical, chemical or electromagnetic stimuli. Such materials, particularly (but not exclusively) textiles, are known as “smart” materials. See, for example, a discussion of smart technology for textiles in Smart Fibres, Fabrics and Clothing, Xiaoming Tao (Editor), published by Woodhead Publishing Ltd (Cambridge, England) and CRC Press LLC (Boca Raton, Fla.), 2001.

Foams of various synthetic polymers are widely used in various applications such as insulating, packaging and cushioning. Ultramicrocellular foams of thermoplastic semicrystalline polymers, first developed by Blades and White (U.S. Pat. No. 3,227,664), exhibit superior tensile strength, food flexibility, and high opacity at low basis weights. The closed cell system of the ultramicrocellular foam provides shock protection, excellent gas retention, and other desirable properties at low apparent densities. While such foams have been used for traditional foam-based applications, no use has been made of them in functional or “smart” materials.

### SUMMARY

One embodiment of this invention is an ultramicrocellular (“UMC”) structure that includes a filler such as a functional filler. Such a UMC structure may be fabricated in the form of a foam, a sheet, a filament, a fiber, a yarn or an extruded profile. A functional filler may modify the UMC structure with respect to properties or performance capabilities in uses for purposes related, for example, to heat regulation, antimicrobial activity, fire resistance, optical properties, antistatic properties, and anticorrosion properties.

Another embodiment of this invention is a process for making a UMC structure that is modified by the incorporation of a filler by contacting the UMC structure with a solution of a filler and a solvent from which there is diffusion of the solvent and filler through the cellular walls and into one or more cells of the UMC structure, and removing the solvent from the UMC structure. Preferably the filler is a functional filler.

A further embodiment of this invention is an article of manufacture fabricated from a filled ultramicrocellular structure. Yet another embodiment of this invention, consequently, is a process for fabricating an article of manufacture, comprising providing a filled ultramicrocellular structure in the form of foam, a sheet, a filament, a fiber, a yarn, or an extruded profile, and fabricating the foam, sheet, filament, fiber, yarn, or extruded profile as an item of apparel, a personal comfort article, a personal care article or a food sanitation article.

### BRIEF DESCRIPTION OF THE DRAWINGS

FIG. 1 depicts a scanning electron micrograph of a cross-section of a PET ultramicrocellular fiber.

FIG. 2 depicts a scanning electron micrograph of a cross-section of a PET ultramicrocellular fiber with incorporated hydroxy-terminated poly(dimethylsiloxane).

FIG. 3 depicts a scanning electron micrograph of a cross-section of a PET ultramicrocellular fiber with incorporated cellulose acetate.

FIG. 4 depicts a scanning electron micrograph of a cross-section of a PET ultramicrocellular fiber with incorporated paraffin wax.

FIG. 5 depicts a scanning electron micrograph of a cross-section of a PET ultramicrocellular fiber with incorporated Hybrane® H1500 hyperbranched polymer.

### DETAILED DESCRIPTION

In this invention, one or more fillers, such as a functional filler, are incorporated into an ultramicrocellular structure. An ultramicrocellular (“UMC”) structure is a crystalline or semicrystalline synthetic organic polymeric structure having the following general properties: (1) substantially all of the polymer is present as closed cells, typically having a polyhedral-shape, that are defined by film-like cell walls having a thickness of less than two micrometers, preferably less than 0.5 micrometer; (2) the cell walls have a substantially uniform thickness, density and texture; (3) there is a uniform crystalline polymer orientation; and (4) there is a uniplanar crystalline polymer orientation. As the cells are inflated, for the UMC structure to be to be supple, opaque and strong, the cell dimensions must be small compared to the smallest external dimension of the structure. For this reason, the average transverse dimension of the cells in expanded condition should be less than 1000 microns, preferably less than 300 microns, and the mutually perpendicular transverse dimensions of a single cell in a fully inflated condition should not vary by more than a factor of three. The ratio of the inflated cell volume to the cube of the wall thickness generally exceeds about 200. The number of cells in the inflated structure is desirably at least about 10³/cm³, and is preferably at least about 10⁵/cm³.

Examples of the UMC structures that may be infused with functional fillers in the practice of this invention include structures fabricated in the form of foam, a sheet, a filament, a fiber or a yarn, or fabricated as an extruded profile in other shapes or forms. A sheet is a thin, flat structure that, when rectilinear, has two dimensions, such as length and width, that are both substantially larger than a third dimension, such as thickness. The area defined by the length and width of a rectilinear sheet is thus a broad, expansive surface as compared to the area defined by the length and thickness, or the width and thickness, which may both be described as only an edge.

As more particularly discussed in Complete Textile Glossary, Celanese Acetate LLC (2001), a fiber is a cylindrical-shaped unit of matter characterized by a length at least 100 times its diameter or width that is capable of being spun into a yarn, or made into a fabric, by various methods such as weaving, knitting, braiding, felting and twisting. For processing on textile machinery, a fiber of the correct length (such as about 1˜8 inches) is needed. A staple or staple fiber has the correct length for such purpose because it is either a natural fiber, and inherently has a useful length, or it is a length of filament that has been cut or broken to the correct length. A filament may thus be thought of as a fiber of an indefinite or extreme length, which is distinguished from a staple fiber in respect of its having not been cut or broken to machine length.

A yarn is a continuous strand of textile fibers or filaments in a form suitable for knitting, weaving, or otherwise intertwining, to form a fabric. For example, yarn can consist of staple fibers bound together by twist (“staple yarn” or “spun yarn”); many continuous filaments with or without twist (“multifilament yarn”); or a single filament with or without twist (“monofilament yarn”).

UMC structures used in the present invention, such as those described above, may be prepared by methods such as flash-spinning or solvent-extrusion. Methods of forming UMC structures such as fibers include those disclosed in U.S. Pat. Nos. 3,227,664; 3,227,784; 3,375,211; 3,375,212; 3,381,077; 3,637,458; and 5,254,400, each of which is incorporated in its entirety as a part hereof for all purposes.

In solvent extrusion, a solution of a synthetic, organic polymer, such as a film-forming polymer, in an activating liquid is first prepared. The solution is subsequently extruded into a region of substantially lower pressure and temperature, wherein the activating liquid rapidly vaporizes, cooling the solution to a temperature at which the polymer precipitates and freezes in orientation.

The primary purpose of the activating liquid is to generate the cells upon flash evaporation, and such liquid generally has the following properties:
a) has a boiling point of at least 10° C., and preferably at least 60° C., below the melting point of the polymer used,
b) is substantially unreactive with the polymer during mixing and extrusion,
c) dissolves less than 1% of the polymer at or below the boiling point of the solvent, and
d) is capable of forming a homogeneous solution with the polymer at elevated temperatures and pressures.
   Suitable activating liquids include, for example, methylene chloride and trichlorofluoromethane.

If the UMC structure is prepared from polyethylene or polypropylene, the extrusion solution may also include a solid nucleating agent to assist in providing a sufficient number of bubble nuclei at the specific instant of extrusion of the solution. Suitable nucleating agents include, for example, fumed silica, available as Cab-O-Sil® from Cabot Corporation (Boston, Mass., USA); kaolin; and talc. In addition, the solution may contain known flash-spinning additives including, without limitation, dyes, ultra-violet light stabilizers, antioxidants and reinforcing particles.

A wide variety of both addition and condensation polymers can be used to form UMC structures suitable for use herein. Typical of such polymers are: polyhydrocarbons such as polyethylene, polypropylene and polystyrene; polyethers such as polyformaldehyde; vinyl polymers such as polyvinyl chloride and polyvinylidene fluoride; polyamides such as polycaprolactam and polyhexamethylene adipamide; polyurethanes such as the polymer obtained from ethylene bischloroformate and ethylene diamine; polyesters such as polyhydroxypivalic acid and poly(ethylene terephthalate); copolymers such as poly(ethylene terephthalate-isophthalate) and their equivalents. Preferred materials are polyesters, including poly(ethylene terephthalate), poly(propylene terephthalate), poly(butylene terephthalate), poly(1,4-cyclohexylene-dimethylene terephthalate) and copolymers thereof. The UMC structure of this invention may be fabricated from one or more polymers and/or copolymers such as those set forth above.

In certain embodiments of this invention, the UMC structure is designed to contain the functional filler and prohibit, restrict, impede or delay diffusion of it out through the cell walls. This type of UMC structure may be distinguished in this respect from a system such as a drug delivery system, which is designed to dispense an active ingredient. In the UMC structures from which filler diffusion is prohibited, restricted, impeded or delayed, polyester homopolymers and copolymers are especially suitable because they provide excellent barriers to diffusion of a wide variety of substances.

Among suitable polyesters are those that contain structural units derived from one or more aromatic diacids (or their corresponding esters) selected from the group consisting of terephthalic acid, isophthalic acid, naphthalene dicarboxylic acids, hydroxybenzoic acids, hydroxynaphthoic acids, cyclohexane dicarboxylic acids, succinic acid, glutaric acid, adipic acid, sebacic acid, 1,12-dodecane dioic acid and the derivatives thereof, such as the dimethyl, diethyl or dipropyl esters or acid chlorides of the dicarboxylic acids; and one or more diols selected from ethylene glycol, 1,3-propane diol, naphthalene glycol, 1,2-propanediol, 1,2-, 1,3-, and 1,4-cyclohexane dimethanol, diethylene glycol, hydroquinone, 1,3-butane diol, 1,5-pentane diol, 1,6-hexane diol, triethylene glycol, resorcinol, isosorbide, and longer chain diols and polyols which are the reaction products of diols or polyols with alkylene oxides.

When a UMC structure of this invention is used for the fabrication of apparel or garments, and such apparel or garments are fabricated primarily from polyester(s) or aliphatic polyamides (e.g. nylon 6 or nylon 66), they often include other components such as acrylic, wool, silk, cotton, linen, flax, hemp, rayon, cellulose, wood pulp, cellulose acetate or triacetate, poly(m-phenylene isophthalamide) (“PMIA”, available from DuPont under the trademark Nomex®), poly(p-phenylene terephthalamide) (“PPTA”, available from DuPont under the trademark Kevlar®), polyolefins such as polypropylene and polyethylene, fiberglass, and Lycra® spandex polymer (available from the Invista unit of Koch Industries, Wilmington, Del.), and elastomers.

A combination of various polymers as discussed above can be used in the present invention for added benefits. In particular embodiments, a combination of polymeric fibers can be prepared by various methods known in the art. For example, a bicomponent fiber, in which two polymeric fibers are arranged side-by-side or in a sheath-core arrangement, can be formed during a spinning process. A poly(ethylene terephthalate)/poly(propylene terephthalate) bicomponent fiber, such as disclosed in U.S. Pat. No. 3,671,379 (which is incorporated in its entirety as a part hereof for all purposes), is one example of a bicomponent fiber useful in the present invention. Another method of preparing a fiber combination is by the intimate blending of staple fibers. For example, as a staple yarn is spun, different fibers can be combined in either a carding or drawing process. A fiber combination can also be prepared by knitting or weaving yarn, staple fiber or filament of different compositions into the same fabric. In one exemplary embodiment, spandex may be added into a staple yarn at either a spinning step or during fabric production, such as plating in knitting.

In a preferred embodiment of the invention, the UMC structure is prepared from poly(ethylene terephthalate) (“PET”); poly(propylene terephthalate) (“3GT”); or mixtures thereof, including copolymers, blends and bicomponent fibers thereof. In another embodiment, the PET and/or 3GT polymer is modified with from about 2 mole percent up to about 5 mole percent of isophthalate units.

In this invention, a UMC structure is modified by the incorporation of a functional filler. A functional filler is a solid, liquid or gaseous substance with which a plurality, and preferably substantially all if not all, of the cells of a UMC structure are infused so as to impart desired properties to the UMC structure with respect to uses for purposes related, for example, to heat regulation, antimicrobial activity, fire resistance, optical properties, antistatic properties, and anticorrosion properties. The presence of the functional filler thus provides in the UMC structure a functional or performance-related attribute or capability that is not provided by the polymeric material itself from which the UMC structure is made, or by an inflatant from which the UMC may have been inflated.

A UMC structure as modified by the incorporation of a functional filler may be obtained by a process such as:

a) providing a UMC structure,

b) dissolving a functional filler in a solvent that plasticizes the cellular walls of the UMC structure,

c) contacting the UMC structure with the solution produced in step (b) for a period of time during which there is diffusion of the solvent and filler from the solution through the cellular walls and into cells of the UMC structure, and

d) removing the solvent from the UMC structure with the result that functional filler remains deposited within the cells.

The process as described above is similar to a method as described in U.S. Pat. Nos. 3,375,211 and 3,375,212 for introducing an inflatant into a UMC fiber except that it is a functional filler that is being introduced into the cells rather than an inflatant. In this method for inflation, a previously formed polymeric fiber is treated with a plasticizing agent that plasticizes, i.e. swells, the cell walls, and a specific inflatant. The inflatant passes-through the cell walls into the interior of the cell. The plasticizing agent is then quickly removed leaving the inflatant trapped within the cells. When the cells are subsequently exposed to air, an osmotic pressure gradient forms allowing air to penetrate and inflate the cells, while the inflatant remains substantially trapped within the cells. The functional filler that is infused into a UMC structure in this invention would be deposited into the interior of the cells by the action of the plasticizing agent in the same manner as is applicable to an inflatant as described in the art relating to inflation of a UMC.

The solvent in which the functional filler is to be dissolved should be capable of dissolving at least 1 wt % of the functional filler with which the UMC structure is to be infused. Additionally, a suitable solvent should plasticize the cell walls of the UMC structure to such an extent that the solution comprising solvent plus functional filler can diffuse through the cell walls at a convenient rate while not compromising the mechanical integrity of the UMC structure. A solvent that plasticizes the cellular walls of the UMC structure is used in the process of this invention because, in performing the function of a plasticizer, the solvent lowers the glass transition temperature of the polymeric material and makes it softer, more flexible, and easier to process. The function of a plasticizer is known in the art from sources such as Encyclopedia of Polymer Science and Technology, 3^{rd} Edition, Volume 3, Pages 498-524 (John Wiley & Sons, New Jersey, 2003).

Solvents that plasticize PVC include, for example, phthalate esters, citrate esters, adipate esters, and phosphate compounds. Solvents that plasticize fluoropolymers include, for example, dioctyl phthalate, dioctyl adipate, and tricresyl phosphate. Solvents that plasticize polyamides include, for example, sulfonamide-based compounds such as N-ethyl, o- or p-toluenesulfonamide, N-butyl benzenesulfonamide, chlorinated solvents and N,N-dimethyl formamide.

Solvents that plasticize aromatic polyesters such as PET, 3GT and poly(butylene terephthalate) (“PBT”) include, for example, dioxane, nitrobenzene, N,N-dimethyl formamide (“DMF”), acetone, and chlorinated solvents such as methylene chloride, tetrachloroethane, perchloroethylene, and 1,2,4-trichlorobenzene). Methylene chloride is preferred because of its unique properties in terms of rapid diffusion and high degree of interaction with polyester. Another practical advantage of methylene chloride is that it is already utilized in a number of pretreatment and after-treatment polyester fiber processes. Methylene chloride has been shown to transport carriers into the polyester structure at low temperature as described for example in Matkowsky, Weigmann and Scott, Text. Chem. Col., 12, 55, 1980; and Moore and Weigmann, Text. Chem. Col., 13, 70, 1981. The plasticization of polyester is discussed further in sources such as Ribnick, Weigmann, and Scott, Text. Res. J., 42, 720 (1972); and Ribnick, Weigmann, and Rebenfeld, ibid. 43, 176 (1973).

To infuse the cells of a UMC structure with a functional filler, the UMC structure is contacted with a solution of the functional filler, typically containing filler at a 1 to 10 wt % concentration, for a time during which there is diffusion of the solution through the walls of the cells and into the UMC structure. The concentration of the filler in the solution may, however, be much higher as may be desired for particular purposes, for example up to at least about 50 wt %. The time sufficient for the diffusion of a desirable amount of the solution into the cells is expected to range from seconds to hours, depending on temperature and on how well the solvent plasticizes the UMC structure. The temperature of the solution should be regulated depending on the properties of the solvent, such as its boiling point and how readily it plasticizes the polymer. The temperature should be high enough to maximize the rate of solution uptake, but not high enough to begin to dissolve the polymer.

When N,N-dimethylformamide (DMF) is used, for example, as a solvent with a polyester UMC structure at room temperature, the DMF causes substantial swelling of the polyester structure, resulting in relaxation of built-in stress and shrinkage. As the treatment temperature increases, crystallization and melting/recrystallization of imperfect crystalline domains can begin to occur (see Ribnick, Weigmann and L. Rebenfeld, ibid.). At this point, the swollen structure is somewhat stabilized and, upon removal of the solvent, a structure of considerable microporosity is produced, increasing the potential filler capacity of the UMC structure. When methylene chloride is used as the solvent for a polyester UMC structure, less than five seconds of contact with the solution at ambient temperature can be sufficient for incorporation of the functional filler.

In other cases, higher temperatures are required for solution uptake to start. When perchloroethylene is used as the solvent, for example, significant uptake does not start until the treatment temperature exceeds about 50° C. At 120° C., equilibrium with perchloroethylene in terms of solvent uptake can be reached in few minutes. However, at this relatively high temperature, relaxation and secondary crystallization can occur, which may substantially modify the polymer. Thus, when perchloroethylene is the solvent, the treatment temperature is preferably between 50 and about 100° C.

Whatever solvent is used, it is removed after filler uptake from the cells of the UMC structure by any appropriate means known in the art, such as ambient air drying, oven drying or vacuum, leaving behind the functional filler deposited into the cells of the UMC structure.

The presence and amount of incorporated functional filler can be determined by weighing samples of the UMC structure after different solution exposure times to determine when filler incorporation has reached a desired level, by microscopy of cross-sections of treated samples, and/or by differential scanning calorimetry. The weight percentage of filler incorporated into a UMC structure will vary depending on the concentration of the filler/solvent solution, the solution temperature at the time of immersion of the structure in the solution, the density of the filler itself, the density of the polymer used to make the UMC structure, and the density of the unfilled UMC structure. Desirable weight percents will depend on the desired function of the particular filler, and the degree of its efficacy in its function. Weight percentages of filler, based on the weight of the UMC structure, in the range of about 20 to about 60, and more particularly in the range of about 30 to about 50, are frequently appropriate, although much higher loadings may be obtained if desired.

In the present invention, a UMC structure is modified by the incorporation of a functional filler to impart desired properties or performance capabilities in uses for purposes related, for example, to heat regulation, antimicrobial activity, insect repellence and insecticidal activity, fire resistance, optical properties, antistatic properties, and anticorrosion properties Useful articles can be fabricated from UMC structures that contain functional filler(s), or, alternatively, an article can be formed first and then subjected to the process of the incorporation of the functional filler(s) therein.

Hyperbranched and dendritic materials [such as described by Hult in “Hyperbranched Polymers,” Encyclopedia of Polymer Science and Technology, 3^{rd} Edition (Volume 2, Pages 722-743, John Wiley & Sons, New Jersey, 2003); by U.S. Ser. No. 02/123,609; and by Kakkar in Macromolecular Symposia (2003), 196 (Metal- and Metalloid-Containing Macromolecules) pages 145-154] can be used as carriers for functional fillers when those fillers are incorporated into a UMC structure. A filler would be attached to reactive functional groups on the arms of the dendrites, especially the termini. Hyperbranched materials suitable for this purpose are readily available commercially, for example, Hybrane® hyperbranched polyesteramides from DSM, and Boltorn® hyperbranched aliphatic polyesters from Perstorp Specialty Chemicals AB.

UMC structures containing a functional filler according to this invention may be fabricated as variety of end-use articles. Such article fall into several broad categories such as:
1. Items of apparel, which include (a) garments such as hats, hoods, masks, scarves, gloves, mittens, jackets, coats, parkas, snowsuits, ski pants, vests, shirts, blouses, sweaters, dresses, skirts, trousers, shorts, pants, socks, stockings, pajamas, nightgowns, thermal underwear, intimate apparel, swimwear, and exposure suits for underwater diving; and (b) foot gear such as shoes, boots, ice skates, sneakers, slippers, and midsoles and liners therefor;
2. Personal comfort articles such as seating for use in home, office, transportation and public and private accommodations; bedding such as in pillows, pillow cases, sheets, comforters, fiberfill, bedspreads, mattresses, mattress covers, bed netting and blankets; window treatments (e.g. curtains and window shades), upholstery, carpeting, linens, potholders, napkins, tablecloths, towels and washcloths; tents; and tarpaulins;
3. Personal care articles such as antimicrobial wipes, handkerchiefs, personal hygiene products (e.g. disposable diapers, cloth diapers, sanitary napkins, tampons, incontinence garments and pads); and medical garments, hats, gloves, drapes and packaging; and
4. Food sanitation articles such as food storage and handling articles, including hats, masks, gloves and aprons; and packaging such as trays, wrappers and cartons, and absorbent antimicrobial pads for meat and poultry packaging.
   These articles may be made by any of the weaving, looming, spinning, forming, molding, sewing, stitching, stapling and bonding operations known in the art.
   Heat Regulation

Heat regulation is a useful property of phase change materials (“PCM”); see, e.g. U.S. Pat. No. 6,004,662 and Tao, op. cit. PCMs are substances that undergo a phase change (e.g. melting, solidification, boiling or condensation) within a particular temperature range that is desirable for a specific application. In many materials, much more heat can be stored as latent heat of phase change than as sensible heat. During a phase change, the temperature of the PCM remains constant while it absorbs energy from, or releases energy to, the surroundings. Paraffin oils and paraffin waxes are examples of PCMs used in heat regulation applications. Thus, in one embodiment of the present invention, a PCM such as a paraffin wax is dissolved in methylene chloride and incorporated into a polyester UMC structure such as a fiber, fabric or mesh containing same. An article made with the UMC structure containing the PCM would demonstrate desirable heat regulation characteristics depending on the temperature of the environment.

Representative examples of PCMs include without limitation glycerol; polyethylene glycol; neopentyl glycol; insoluble fatty acids of natural oils and waxes such jojoba wax, cotton seed oil, corn oil, castor oil, coconut, almond, beechnut, black mustard, candlenut, cotton seed stearin, esparto, poppy seed, rape seed, canola, pumpkin seed, soy bean, sunflower, walnut, white mustard seed, and beeswax; hydrocarbon paraffins such as n-tetradecane, n-pentadecane, n-hexadecane, n-heptadecane, n-octadecane, n-nonadecane, n-eicosane, n-heneicosane, n-decosane; trimethylethane; C₁₆-C₂₂ alkyl hydrocarbons; mineral oil; natural rubber; polychloroprene; microcrystalline hydrocarbon waxes such as MULTIWAX® (Crompton Corporation, Witco Refined Products, Tarrytown, N.Y., USA); pentaerythritol; polyhydric alcohols; and acrylate and methacrylate polymers with C₁₆-C₁₈ alkyl side chains.

UMC structures that incorporate a PCM as a functional filler according to this invention may be fabricated into a variety of end-use articles such as items of apparel and personal comfort articles.

Antimicrobial and Antiodor Functionality

Antimicrobial and antiodor agents can also be incorporated as functional fillers in the present invention. An antimicrobial agent is a bactericidal, fungicidal (including activity against molds), and/or antiviral agent. These include, for example, chitosan and its derivatives, such as N-carboxymethyl chitosan, N-carboxybutyl chitosan, phosphorylated chitosan, chitosan lactate, chitosan glutamate, amphoteric polyaminosaccharides; and blends of chitosan with poly(vinyl alcohol), with polysaccharides, or with cellulosic derivatives. Other suitable antimicrobial functional fillers include without limitation triclosan, cetyl pyrridinium chloride, polybiguanide-based compounds; and the alkyl (especially methyl, ethyl, propyl, and butyl) and benzyl esters of 4-hydroxybenzoic acid, which are commonly referred to as “parabens”. Polybiguanide-based compounds are known to demonstrate antiviral activity (see, e.g., U.S. Ser. No. 04/009,144) as well as antimold activity and antibacterial activity (see, e.g., G.B. 1,434,040), an example of which is poly(hexamethylenebiguanide) (“PHMBG”) and its derivatives. Use of a specific antimicrobial or antiodor functional filler with a specific UMC structure will require a solvent that will dissolve the functional filler, and plasticize but not dissolve the UMC structure. In some cases, it may be necessary to chemically functionalize the filler to enhance its solubility in a particular solvent.

UMC structures containing an antimicrobial and/or antiodor functional filler according to this invention may be fabricated into a variety of end-use articles such as items of apparel, personal comfort articles, personal care articles, and food sanitation articles.

Insecticidal and Insect Repellent Functionality

Insecticides and insect repellents can also be used as functional fillers in the present invention. Examples include without limitation N,N-diethyl-m-toluamide (“DEET”); dihydronepetalactone and derivatives thereof; essential oils such as citronella oil, backhousia citriodora oil, melaleuca ericafolia oil, callitru collumellasis (leaf) oil, callitrus glaucophyla oil, and melaleuca linarifolia oil; and pyrethoid insecticides, such as but not limited to permethrin, deltamethrin, cyfluthrin, alpha-cypermethrin, etofenprox, and lambda-cyhalthrin.

UMC structures containing an insecticidal and/or insect repellent functional filler according to this invention may be fabricated into a variety of end-use articles such as items of apparel and personal comfort articles. For example, bed nets made from a UMC structure that contains an insecticide or insect repellent as a functional filler could be used for protection against insect-transmitted diseases such as malaria.

Flame Retardant Functionality

Flame retardant compounds that are soluble in a suitable solvent for the specific polymer are also suitable for use as a functional filler to increase noninflammability of a UMC structure. A few examples are polyphenylene oxide (“PPO”) and halogen- and phosphorous-containing flame retardants including without limitation decabromodiphenyl oxide, cyclic phosphonate esters, triphenyl phosphate, and poly(sulfonyldiphenylene phenylphosphonate). Flame retardants useful herein as functional fillers also include those textile-specific flame retardants disclosed by Calamari and Harper in Kirk-Othmer Encyclopedia of Chemical Technology, 4^{th} edition, Volume 10, Pages 999-1022 (John Wiley & Sons, 1996), and those phosphorus-based flame retardants disclosed by Weil in Kirk-Othmer Encyclopedia of Chemical Technology, 4^{th} edition, Volume 10, Pages 976-998 (John Wiley & Sons, 1996).

UMC structures containing a flame retardant functional filler according to this invention may be fabricated into a variety of end-use articles such as items of apparel and personal comfort articles.

Electrochromic, Thermochromic and Photochromic Functionality

Novel properties can be obtained according to this invention by incorporating materials that are electrochromic, thermochromic or photochromic as a functional filler in a UMC structure. UMC structures containing a electrochromic, thermochromic or photochromic functional filler according to this invention may be fabricated into a variety of end-use articles such as personal comfort articles.

An electrochromic material is a material that switches between darkened and lightened states as a small voltage is applied and withdrawn. When a small voltage is applied, the material changes to a darkened state, and returns to a lightened state when the voltage is reversed. Electrochromic materials suitable for use in a UMC structure according to this invention include those disclosed by Rowley and Mortimer in “New Electrochromic Materials”, Science Progress, 2002, 85(3), 243-262; and those disclosed by Samat and Guglielmetti in Kirk-Othmer Encyclopedia of Chemical Technology, 5^{th} edition, Volume 6, Pages 571-587 (John Wiley & Sons, 2004). Examples of particular electrochromic materials suitable for use herein include without limitation thiophene electrochromes, viologens (1,1′-disubstituted-4,4′-bipyridinium salts), and conducting polymers such as polypyrrole.

UMC structures containing an electrochromic functional filler according to this invention may be fabricated, for example, into articles such as actively controlled window treatments. Shades or curtains that could be used in “smart window” applications would allow the window to be adjusted to maximize energy performance with varying outdoor conditions. During the day, for example, the window could be darkened to reduce solar heat gain.

A thermochromic material is a material that can change from one color into another color according to a change in temperature, and can return to its original color when it returns to its original temperature. Thermochromic materials suitable for use in a UMC structure according to this invention include those disclosed by Samat and Guglielmetti in Kirk-Othmer Encyclopedia of Chemical Technology, 5^{th} edition, Volume 6, Pages 614-631 (John Wiley & Sons, 2004). Examples of particular thermochromic materials suitable for use in this invention include without limitation di-beta-naphthospiropyran [CAS 178-10-9], poly(xylylviologen dibromide [CAS 38815-69-9] and ETCD polydiacetylene [CAS 63809-82-5].

A photochromic material is a material that can change from one color into another color according to a change in incident light (typically ultraviolet rays), and can return to its original color when the light is removed. Photochromic materials suitable for use in a UMC structure according to this invention include those disclosed by Samat and Guglielmetti in Kirk-Othmer Encyclopedia of Chemical Technology, 5^{th} edition, Volume 6, Pages 587-606 (John Wiley & Sons, 2004). Examples of particular photochromic materials suitable for use in this invention include without limitation azobenzene, dio-indigo, salicylitene aniline, benzopyrane-based compounds, naphthopyrane-based compounds, spiroxazine-based compounds, and spiropyrane-based compounds.

Surface Property Control

Surface properties can also be modified by the incorporation of a surface modifying agent as a functional filler in a UMC structure according to this invention. Some functional fillers, such as poly(dimethylsiloxane), can be used to increase the hydrophobicity of the surface of a UMC structure and thus its water-repellency. Dyeability and adhesion can also be improved by incorporating into a UMC structure a functional filler with polar, hydrophilic sites, such as cellulose acetate or hyperbranched materials like Hybrane® and Boltorn® hyperbranched polymers (vide supra).

Articles with improved antistatic properties can be made from a UMC structure that contains an antistatic agent, such as chitosan and its derivatives, glycerol monostearate, an ethoxylated amine, or an alkyl sulfonate. Antistatic properties refer to the ability of a textile material to disperse an electrostatic charge and to prevent the buildup of static electricity, as more fully described in Dictionary of Fiber & Textile Technology [Hoechst Celanese Corp., Charlotte, N.C. (1990), page 8].

UMC structures containing a surface modifying agent as a functional filler according to this invention may be fabricated into a variety of end-use articles such as items of apparel, personal comfort articles, personal care articles, and food sanitation articles.

### EXAMPLES

The present invention is further defined in the following examples that, while indicating preferred embodiments of the invention, are given by way of illustration only.

The meaning of abbreviations is as follows: “(m)g” means (milli)gram(s), “wt %” means weight percent (age), “Mₙ” means number average molecular weight, “h” means hour, “min” means minute, “s” means second(s), “DSC” means differential scanning calorimetry, and “T_{g}” means glass transition temperature.

### Example 1

### PET UMC Fiber Control

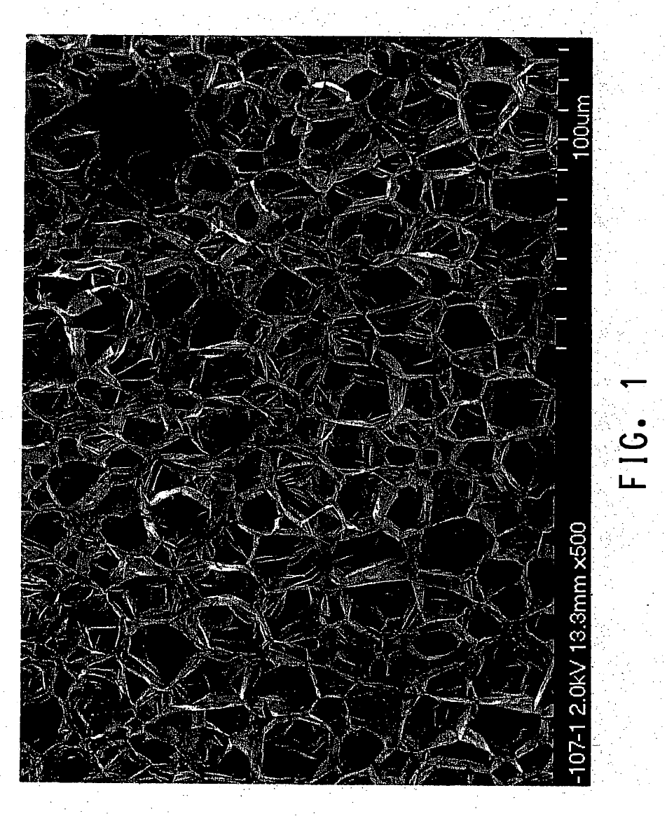

A poly(ethylene terephthalate) (“PET”) UMC fiber prepared by flash spinning was immersed in methylene chloride at room temperature for one second and then allowed to dry in air on a paper towel. The fiber weighed 0.0568 g before immersion and 0.0553 g after immersion and drying. Analysis of the dried fiber by DSC and scanning electron microscopy confirmed that no solvent had been retained. A scanning electron micrograph of the dried fiber is presented as FIG. 1.

### Example 2

### Incorporation of Hydroxy-terminated poly(dimethylsiloxane) in PET UMC Fiber

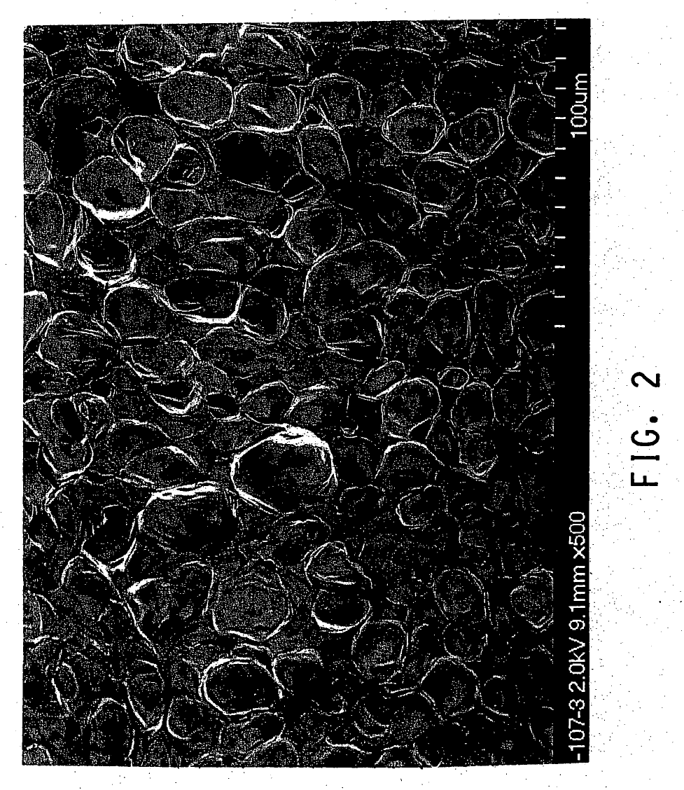

Hydroxy-terminated poly(dimethylsiloxane), HO[—Si(CH₃)₂O—]ₙH, with viscosity approximately equal to 1000 cSt (0.001 m²/s) and Mₙ about 6,000 was obtained from Aldrich Chemical Company, Milwaukee, Wis. (catalog number 48,197-1). A 10% by weight solution of this polymer in methylene chloride was prepared. A sample of a PET UMC fiber as described in Example 1 was immersed in this solution for one second and then allowed to dry in air on a paper towel. The fiber weighed 0.0556 g before immersion and 0.1327 g after immersion and drying. Analysis of the dried fiber by DSC and scanning electron microscopy confirmed pore filling by the hydroxyl terminated poly(dimethylsiloxane). A scanning electron micrograph of the dried fiber is presented as FIG. 2.

### Example 3

### Effect of Immersion Time on the Uptake of the Functional Filler

A 10% by weight solution of the hydroxy terminated poly(dimethylsiloxane) used in Example 2 (“PDMSiHT”) in methylene chloride was prepared at room temperature. PET UMC fibers were immersed in the solution for different times. Then the fibers were allowed to dry in ambient air. The weight of fibers used for each experiment was recorded before immersion and after the immersion and drying process.

The results are shown below:

3A

| | Immersion | Initial Fiber | Final Fiber | Weight |
|---|---|---|---|---|
| | Time | Weight | Weight | Increase |
| No. | (seconds) | (mg) | (mg) | (%) |
| 1 | 1 | 1.0 | 1.9 | 90 |
| 2 | 10 | 1.1 | 2.9 | 163 |

3B

| | Immersion | Initial Fiber | Final Fiber | Weight |
|---|---|---|---|---|
| | Time | Weight | Weight | Increase |
| No. | (seconds) | (mg) | (mg) | (%) |
| 1 | 120 | 1.5 | 2.6 | 73 |
| 2 | 240 | 1.5 | 2.9 | 93 |

3C

| | Immersion | Initial Fiber | Final Fiber | Weight |
|---|---|---|---|---|
| | Time | Weight | Weight | Increase |
| No. | (seconds) | (mg) | (mg) | (%) |
| 1 | 60 | 2.8 | 4.8 | 71 |
| 2 | 120 | 2.9 | 7.1 | 144 |
| 3 | 240 | 2.8 | 6.0 | 114 |

These results indicated that the filler uptake varied according to the weight of the fiber and the amount of the immersion time. A saturation was observed, however, after 240 seconds immersion time for the samples of the 2.8 mg category.

### Example 4

### Effect of the Functional Filler Concentration on Uptake

Several concentrations (1-80% by weight) of the hydroxy terminated poly(dimethylsiloxane) used in Example 2 (PDMSiHT) were made in methylene chloride. Six sets of fibers were immersed for 1 second in these solutions. The fibers were weighed before and after immersion/drying process. The results are shown in the following table.

| | | | | Final | |
|---|---|---|---|---|---|
| | PDMSiHT | Initial | | Fiber | |
| | wt. % in | Fiber | Immersion | weight | wt. % |
| No. | CH₂Cl₂ | wt. (mg) | time (s) | (mg) | increase |
| 1 | 1 | 1.6 | 1 | 1.6 | 0 |
| 2 | 5 | 1.7 | 1 | 2.9 | 71 |
| 3 | 10 | 1.9 | 1 | 3.2 | 68 |
| 4 | 20 | 1.8 | 1 | 5.2 | 189 |
| 5 | 50 | 1.9 | 1 | 8.3 | 337 |
| 6 | 80 | 1.7 | 1 | 13.7 | 706 |

### Example 5

### Incorporation of Cellulose Triacetate in PET UMC Fiber

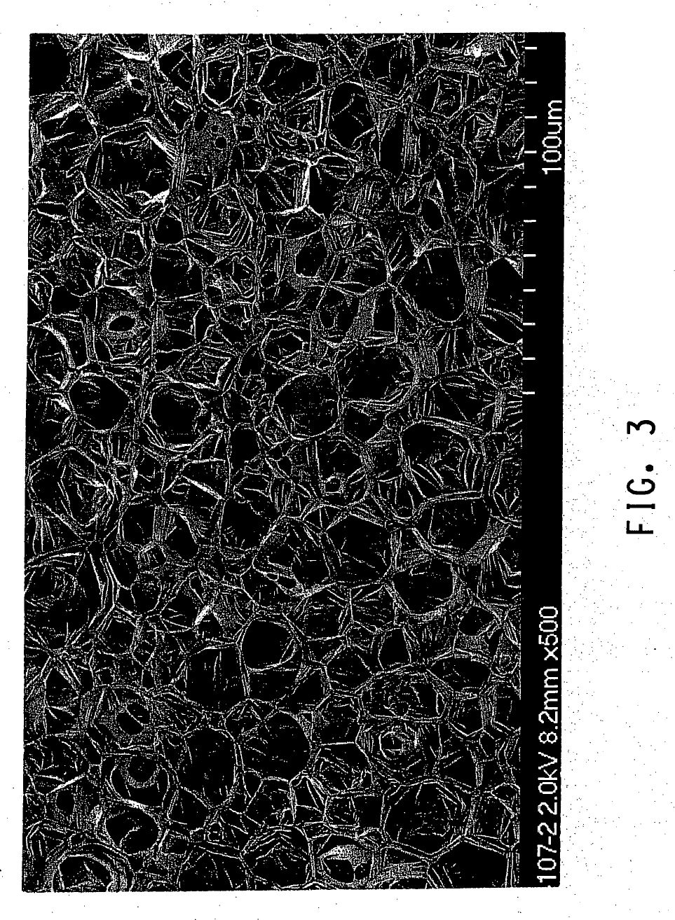

A 5% by weight solution of cellulose triacetate in methylene chloride was prepared. A sample of PET UMC fiber as in Example 1 was immersed in this solution for one second and then allowed to dry in air on a paper towel. The fiber weighed 0.0692 g before immersion and 0.1090 g after immersion and drying. Analysis of the dried fibers by DSC and scanning electron microscopy confirmed pore filling by the cellulose triacetate. A scanning electron micrograph of the dried fiber is presented as FIG. 3.

### Example 6

### Incorporation of Paraffin Wax in PET UMC Fiber

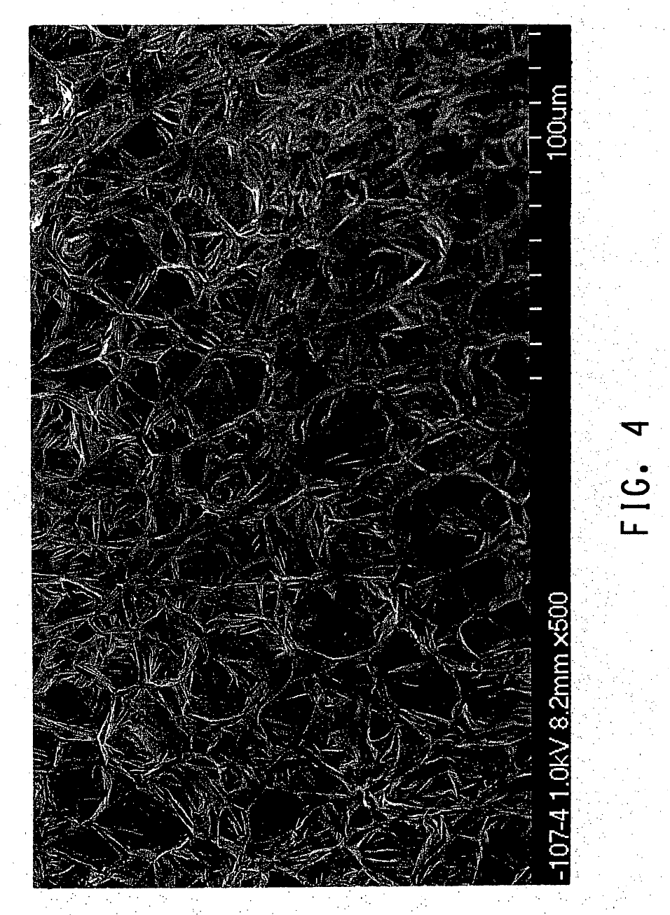

A 10% by weight solution of paraffin wax in methylene chloride was prepared. A sample of polyester PET UMC fiber as in Example 1 was immersed in this solution for one second and then allowed to dry in air on a paper towel. The fiber weighed 0.0589 g before immersion and 0.0758 g after immersion and drying. Analysis of the dried fibers by DSC and scanning electron microscopy confirmed pore filling by the paraffin wax. A scanning electron micrograph of the dried fiber is presented as FIG. 4.

### Example 7

### Incorporation of Hyperbranched Polymer Hybrane® H1500 in PET UMC Fiber

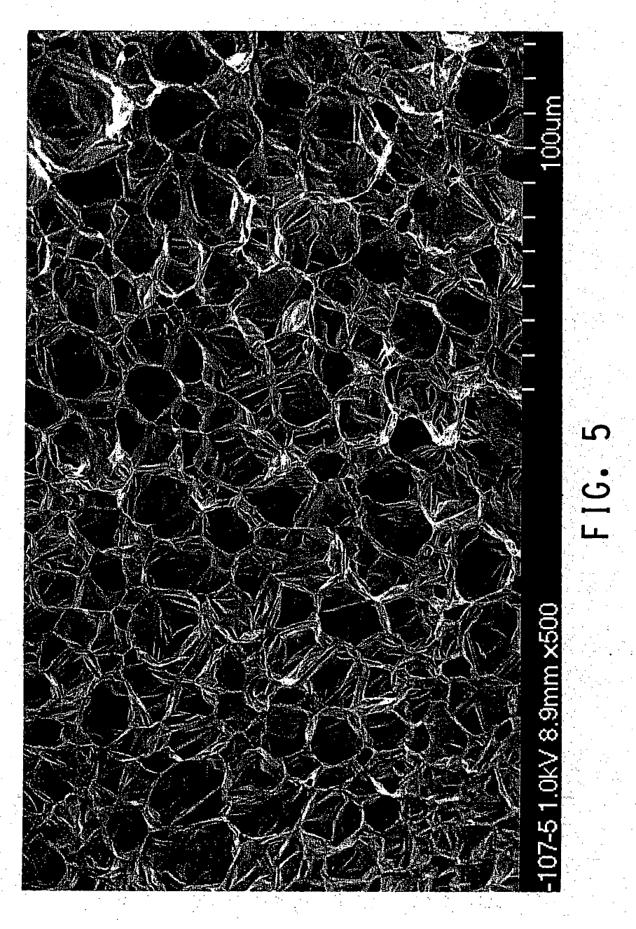

A 10% by weight solution of Hybrane® H1500 plymer, a hyperbranched poly(ester/amide) with Mₙ=1500 and T_{g}=72° C., was prepared in methylene chloride. A sample of PET UMC fiber as in Example 1 was immersed in this solution for one second and then allowed to dry in air on a paper towel. The fiber weighed 0.0641 g before immersion and 0.1308 g after immersion and drying. Analysis of the dried fibers by DSC and scanning electron microscopy confirmed pore filling by the hyperbranched polymer. A scanning electron micrograph of the dried fiber is presented as FIG. 5.

### Example 8

### Preparation of Flame Retardant UMC PET

A woven fabric of UMC polyester staple fiber is soaked in a 10 wt % solution of poly(sulfonyldiphenylene phenylphosphonate) in methylene chloride at room temperature for five minutes, is removed from solution, and is allowed to dry under ambient conditions. The oxygen index of the treated fabric increases significantly versus a piece of untreated fabric.

### Example 9

### Preparation of Antimicrobial UMC Polyamide

A woven fabric of UMC polyhexamethylene adipamide staple fiber is soaked for 30 minutes in a 2% solution in 0.75% aqueous formic acid of chitosan (ChitoClear® TM656, obtained from Primex, Norway, molecular weight about 70,000, degree of deacetylation over 90%). The fabric is then taken out and the excess chitosan solution is removed by suction under vacuum and allowed to dry in air for 24 h, followed by heating to 60° C. for 1 h. Both the treated fabric and a piece of the untreated UMC polyhexamethylene adipamide fabric are tested for antimicrobial efficacy against E. Coli ATCC 25922 by the Shake Flask Test for Antimicrobial Testing of Materials.

After 4 hours, the number of Colony Forming Units per ml decreases for the chitosan-treated UMC fabric, versus essentially no decrease for the untreated UMC fabric.

### Example 10

### Insecticidal UMC Polypropylene Netting

Polypropylene netting, 100 denier, is prepared containing 10% UMC polypropylene by volume. A 10 cm×10 cm piece of the netting is covered with Pounce® 3.2 EC permethrin formulation [permethrin (38.4%) and inert ingredients (61.6%), including aromatic hydrocarbons (<32.2%), 1,2,4-trimethylbenzene (<16.4%), xylene (<10.2%), surfactant blend (<7%), ethylbenzene (<2%), cumene (<2%), and 1-butanol (<1%)] available from FMC Corporation (Philadelphia, Pa.) for 10 minutes at room temperature and then removed. Excess permethrin formulation is removed by squeezing and wiping. The treated netting is allowed to dry for a few hours under ambient conditions.

The treated netting and a piece of untreated netting are tested for insecticidal efficacy using the WHO cone bioassay test. Ten adult Anopheles gambiae mosquitoes are used per assay, and 3 such assays are run per sample. In each assay, the mosquitoes are exposed to the netting for 3 min, then held in a clean carton with sugar water for nourishment. Dead mosquitoes are counted 30 min after exposure to the netting. The vast majority of the mosquitoes exposed to the treated netting die within 30 minutes, while the mosquitoes exposed to the untreated netting are all still alive.

### Example 11

### Photochromic UMC Polypropylene Foam Sheet

UMC polypropylene foam sheet, about 0.6 mm thick, is prepared from isotactic polypropylene and 90:10 fluorotrichloromethane/dichlorotetrafluoroethane using the procedure described in Example 1 of U.S. Pat. No. 3,637,458. A solution of 200 g of toluene, 200 g of methylethylketone and 0.5 g spiropyrane-based photochromic compound is prepared at room temperature. A 15 cm×15 cm piece of the UMC foam sheet is immersed in the solution for 1 h at 50° C., removed from the solution, and then dried for 2 h at 50° C.

Where a UMC structure or method of this invention is stated or described as comprising, including, containing, having, being composed of or being constituted by certain components or steps, it is to be understood, unless the statement or description explicitly provides to the contrary, that one or more components or steps other than those explicitly stated or described may be present in the UMC structure or method. In an alternative embodiment, however, the UMC structure or method of this invention may be stated or described as consisting essentially of certain components or steps, in which embodiment components or steps that would materially alter the principle of operation or the distinguishing characteristics of the UMC structure or method would not be present therein. In a further alternative embodiment, the UMC structure or method of this invention may be stated or described as consisting of certain components or steps, in which embodiment components or steps other than those as stated would not be present therein.

Where the indefinite article “a” or “an” is used with respect to a statement or description of the presence of a component in a UMC structure, or a step in a method, of this invention, it is to be understood, unless the statement or description explicitly provides to the contrary, that the use of such indefinite article does not limit the presence of the component in the UMC structure, or of the step in the method, to one in number.

Where a range of numerical values is recited herein, unless otherwise stated, the range is intended to include the endpoints thereof, and all integers and fractions within the range. It is not intended that the scope of the invention be limited to the specific values recited when defining a range.

We claim:

1. An ultramicrocellular structure comprising a phase change material.

2. An ultramicrocellular structure according to claim 1 wherein the phase change material is selected from the group consisting of glycerol, polyethylene glycol, neopentyl glycol, insoluble fatty acids of natural oils and waxes, n-tetradecane, n-pentadecane, n-hexadecane, n-heptadecane, n-octadecane, n-nonadecane, n-eicosane, n-heneicosane, n-decosane, trimethylethane, C₁₆-C₂₂ alkyl hydrocarbons, mineral oil, natural rubber, polychloroprene, microcrystalline hydrocarbon waxes, pentaerythritol, polyhydric alcohols, and acrylate and methacrylate polymers with C₁₆-C₁₈ alkyl side chains.

3. An ultramicrocellular structure according to claim 2 wherein the insoluble fatty acids of natural oils and waxes are selected from the group consisting of such jojoba wax, cotton seed oil, corn oil, castor oil, coconut, almond, beechnut, black mustard, candlenut, cotton seed stearin, esparto, poppy seed, rape seed canola, pumpkin seed, soy bean, sunflower, walnut, white mustard seed, and beeswax.

4. An ultramicrocellular structure comprising an antimicrobial or antiodor agent.

5. An ultramicrocellular structure according to claim 4 wherein the antimicrobial agent is selected from the group consisting of chitosan and its derivatives; blends of chitosan with poly(vinyl alcohol), with polysaccharides, or with cellulosic derivatives; triclosan, cetyl pyrridinium chloride, polybiguanide-based compounds; and the methyl, ethyl, propyl, butyl and benzyl esters of 4-hydroxybenzoic acid.

6. An ultramicrocellular structure according to claim 5 wherein the derivative of chitosan is selected from the group consisting of N-carboxymethyl chitosan, N-carboxybutyl chitosan, phosphorylated chitosan, chitosan lactate, chitosan glutamate, and amphoteric polyaminosaccharides.

7. An ultramicrocellular structure comprising an insecticide or insect repellent.

8. An ultramicrocellular structure according to claim 7 wherein the insecticide or insect repellent is selected from the group consisting of N,N-diethyl-m-toluamide, dihydronepetalactone, essential oils, and pyrethoid insecticides.

9. An ultramicrocellular structure according to claim 8 wherein the essential oil is selected from the group consisting of backhousia citriodora oil, melaleuca ericafolia oil, callitru collumellasis (leaf) oil, callitrus glaucophyla oil, citronella oil, and melaleuca linarifolia oil.

10. An ultramicrocellular structure according to claim 8 wherein the pyrethoid insecticide is selected form the group consisting of permethrin, deltamethrin, cyfluthrin, alpha-cypermethrin, etofenprox, and lambda-cyhalthrin.

11. An ultramicrocellular structure comprising a flame retardant.

12. An ultramicrocellular structure according to claim 11 wherein the flame retardant is selected from the group consisting polyphenylene oxide, halogen-containing flame retardants, and phosphorous-containing flame retardants.

13. An ultramicrocellular structure according to claim 12 wherein the halogen-containing flame retardant is decabromodiphenyl oxide.

14. An ultramicrocellular structure according to claim 12 wherein the phosphorus-containing flame retardant is selected from the group consisting of cyclic phosphonate esters, triphenyl phosphate, and poly(sulfonyldiphenylene phenylphosphonate).

15. An ultramicrocellular structure comprising an electrochromic, thermochromic or photochromic compound.

16. An ultramicrocellular structure according to claim 15 that comprises an electrochromic compound.

17. An ultramicrocellular structure according to claim 15 that comprises a thermochromic compound.

18. An ultramicrocellular structure according to claim 15 that comprises a photochromic compound.

19. An ultramicrocellular structure according to claim 15 wherein the electrochromic compound is selected from the group consisting of thiophene electrochromes, viologens, and conducting polymers.

20. An ultramicrocellular structure according to claim 15 wherein the photochromic compound is selected from the group consisting of azobenzene, dio-indigo, salicylitene aniline, benzopyrane-based compounds, naphthopyrane-based compounds, spiroxazine-based compounds, and spiropyrane-based compounds.

21. An ultramicrocellular structure according to claim 15 wherein the thermochromic compound is selected from the group consisting of di-beta-naphthospiropyran, poly(xylylviologen dibromide, or ETCD polydiacetylene.

22. An ultramicrocellular structure comprising a surface modifying agent.

23. An ultramicrocellular structure according to claim 22 wherein the surface modifying agent increases the hydrophobicity of the surface of the structure.

24. An ultramicrocellular structure according to claim 22 wherein the surface modifying agent comprises an antistatic agent.

25. An ultramicrocellular structure according to claim 24 wherein the antistatic agent is selected from the group consisting of chitosan and its derivatives, glycerol monostearate, ethoxylated amines, and alkyl sulfonates.

26. An ultramicrocellular structure according to claim 1, 4, 7, 11, 15 or 22 that is fabricated from one or more polymers selected from the group consisting of polyethylene, polypropylene, polystyrene, polyether, polyvinyl chloride, polyvinylidene fluoride, polyamide, polyurethane, and polyester homo- and co-polymers.

27. An ultramicrocellular structure according to claim 1, 4, 7, 11, 15 or 22 that is fabricated in the form of foam, a sheet, a filament, a fiber, a yarn, or an extruded profile.

28. An ultramicrocellular structure according to claim 27 that is fabricated as an item of apparel, a personal comfort article, a personal care article or a food sanitation article.

29. A process for fabricating an article of manufacture, comprising providing a filled ultramicrocellular structure in the form of foam, a sheet, a filament, a fiber, a yarn, or an extruded profile, and fabricating the foam, sheet, filament, fiber, yarn, or extruded profile as an item of apparel, a personal comfort article, a personal care article or a food sanitation article.
